(19) United States
(12) Patent Application Publication
(10) Pub. No.: US 2026/0228429 A1
(43) Pub. Date: Aug. 6, 2026

(54) METHOD FOR EVALUATING TEXT

(71) Applicant: INTERACTIVE SOLUTIONS CORP., Chiyoda-ku, Tokyo (JP)

(72) Inventor: Kiyoshi SEKINE, Chiyoda-ku, Tokyo (JP)

(73) Assignee: INTERACTIVE SOLUTIONS CORP., Chiyoda-ku, Tokyo (JP)

(21) Appl. No.: 19/121,797

(22) PCT Filed: Oct. 16, 2023
(86) PCT No.: PCT/JP2023/037438

§ 371 Date: Apr. 16, 2025

(30) Foreign Application Priority Data
Oct. 21, 2022 (JP) 2022-169511

(51) Int. Cl. G06F 40/253

(52) U.S. Cl. CPC G06F 40/253

(57) ABSTRACT

[Problem] To provide a computer-based method for evaluating a text that can also evaluate a context. [Solution]A method for evaluating a text by a computer, comprising: a text input step in which a text to be evaluated is input into the computer; an in-text word extracting step of extracting an in-text word as a word included in the text to be evaluated by the computer; a key sentence extracting step of extracting a key sentence included in the text to be evaluated by the computer, the key sentence including one or more in-text words and one or more postpositional particles; and a text evaluating step of evaluating the text on a basis of the key sentence by the computer, wherein the text evaluating step includes a step of reading evaluation information relating to the key sentence from a storage unit, and the evaluation information is information relating to whether the key sentence is correct as the text to be evaluated, or information relating to which category the key sentence belongs to.

### TECHNICAL FIELD

This invention relates to a computer-based method and system for evaluating a text.

### BACKGROUND ART

Japanese Patent No. 7049010 describes a presentation evaluation system.

The above evaluation system evaluates a content of a conversation or a person who had the conversation based on a count of keywords, a count of related terms, a combination of keywords, or a combination of related terms. In this case, there has been an issue in which the system evaluates the conversation as correct when the conversation includes keywords and the like even if the conversation is incorrect in context.

### CITATION LIST

### Patent Literature

Patent Literature 1: Japanese Patent No. 7049010

### SUMMARY OF INVENTION

### Technical Problem

An object of this invention is to provide a computer-based method for evaluating a text that can also evaluate a context.

An object of this invention is to provide a learning support method using the above evaluation method.

An object of this invention is to provide a method for obtaining a subsequent text to a given text after evaluating the context so that role-playing can be performed.

### Solution to Problem

This method basically relates to a method for evaluating a text by using a key sentence that includes a postpositional particle, enabling a correct understanding of a context.

This method is a method for evaluating the text either on the basis of or using the key sentence by a computer.

Examples of this method include a text input step (S101), an in-text word extracting step (S102), a key sentence extracting step (S103), and a text evaluating step (S104).

The text input step (S101) is a step in which a text to be evaluated is input into the computer.

The in-text word extracting step (S102) is a step of extracting an in-text word as a word included in the text to be evaluated by the computer.

The key sentence extracting step (S103) is a step of extracting a key sentence included in the text to be evaluated by the computer. The key sentence includes one or more in-text words and one or more postpositional particles.

The text evaluating step (S104) is a step of evaluating the text either on the basis of or using the key sentence by the computer.

Examples of the text input step (S101) include a step in which speech is input into the computer and a step of analyzing the speech input into the computer to obtain the text to be evaluated by the computer.

Examples of the text to be evaluated include a descriptive text or an answer text.

Examples of the in-text word include a word stored in an in-text word storage unit that stores in-text words associated with the text to be evaluated.

Examples of the key sentence include a key sentence stored in a key sentence storage unit that stores key sentences associated with the text to be evaluated.

Examples of the key sentence are allowed to include a group of words that are either contiguous or dispersed within the text to be evaluated.

Examples of the use of the above method include a computer-based learning support method.

Another example of the use of the above method relates to a computer-based method for creating a subsequent text.

This method further includes a subsequent text creating step (S105). The subsequent text creating step (S105) is a step of obtaining a subsequent text as a text following the text to be evaluated based on the evaluation. The computer includes a subsequent text storage unit that stores a subsequent text corresponding to the evaluation. Then, in the subsequent text creating step (S105), the computer reads the subsequent text corresponding to the evaluation using the evaluation of the text to be evaluated.

This specification also discloses a system for evaluating a text by a computer.

A system 1 is a system in which the computer evaluates the text. The system 1 includes a text input unit 3, an in-text word extracting unit 5, a key sentence extracting unit 7, and a text evaluating unit 9.

The text input unit 3 is an element for inputting a text to be evaluated.

The in-text word extracting unit 5 is an element for extracting an in-text word as a word included in the text to be evaluated.

The key sentence extracting unit 7 is an element for extracting a key sentence included in the text to be evaluated. The key sentence includes one or more in-text words and one or more postpositional particles.

The text evaluating unit 9 is an element for evaluating the text based on the key sentence.

This specification also discloses a learning support system that uses the system described above.

This specification also discloses a system for creating a subsequent text using the system described above. The system for creating a subsequent text includes a subsequent text creating unit.

This specification also discloses a program for causing a computer to execute the above method or to function as the system described above, as well as a non-transitory computer readable information recording medium that stores the program.

### Advantageous Effects of Invention

This invention can provide a computer-based method for evaluating a text that can also evaluate a context.

This invention can provide a learning support method using the evaluation method described above.

This invention can provide a method for obtaining a subsequent text to a given text after evaluating the context so that role-playing can be performed.

### BRIEF DESCRIPTION OF DRAWINGS

FIG. 1 is a flowchart for describing a method for evaluating a text using a computer.

FIG. 2 is a block diagram illustrating an exemplary configuration of a system for evaluating a text by a computer.

FIG. 3 is a diagram illustrating an overview of an experiment in Example 1.

FIG. 4 is a diagram illustrating exemplary implementation of iRolePlay (registered trademark).

FIG. 5 is a graph substituting a diagram illustrating verification of memory retention in word memorization learning.

FIG. 6 is a graph substituting a diagram illustrating a retention rate of word descriptive texts using speech learning.

FIG. 7 is a conceptual diagram describing a concept of role-playing.

FIG. 8 is a conceptual diagram illustrating an example of role-playing in which the response of an AI doctor branches based on answers provided by an MR.

### DESCRIPTION OF EMBODIMENTS

Hereinafter, an embodiment of this invention will be described with reference to the drawings. This invention is not limited to the embodiment described below but also includes modifications appropriately made within the scope apparent to those skilled in the art from the following embodiment.

This method basically relates to a method for evaluating a text by using a key sentence that includes a postpositional particle, enabling a correct understanding of a context. In this method, a computer evaluates the text either on the basis of or using the key sentence.

“Evaluating a text” may refer to interpreting whether the text is a correct answer, interpreting which category the text belongs to, or assessing the quality of the text.

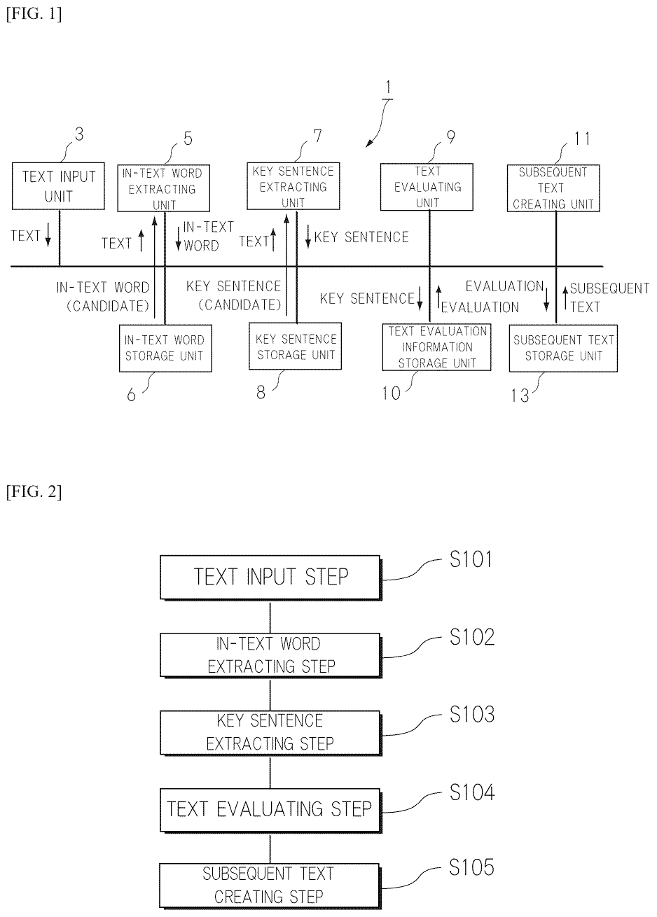

FIG. 1 is a flowchart for describing a method for evaluating a text using a computer. As illustrated in FIG. 1, examples of this method include a text input step (S101), an in-text word extracting step (S102), a key sentence extracting step (S103), and a text evaluating step (S104). This method may further include a subsequent text creating step (S105). “S” stands for a step (process).

FIG. 2 is a block diagram illustrating an exemplary configuration of a system for evaluating a text by a computer. As illustrated in FIG. 2, a system 1 includes a text input unit 3, an in-text word extracting unit 5, a key sentence extracting unit 7, and a text evaluating unit 9. This system may further include one or more of an in-text word storage unit 6, a key sentence storage unit 8, and a text evaluation information storage unit 10. This system 1 may further include a subsequent text creating unit 11. In a case where the system 1 includes the subsequent text creating unit 11, the system 1 may further include a subsequent text storage unit 13. The text input unit 3 is an element for inputting a text to be evaluated. The in-text word extracting unit 5 is an element for extracting an in-text word as a word included in the text to be evaluated. The key sentence extracting unit 7 is an element for extracting a key sentence included in the text to be evaluated. The text evaluating unit 9 is an element for evaluating the text either on the basis of or using the key sentence. The subsequent text creating unit 11 is an element for obtaining a subsequent text as a text following the text to be evaluated. The system 1 is a computer-based system for executing the method described above.

The computer includes an input unit, an output unit, a control unit, an arithmetic unit, and a storage unit, and each of the units is connected via a bus or the like, enabling an exchange of information. For example, the storage unit may store a control program or various kinds of information. Upon input of predetermined information from the input unit, the control unit reads the control program stored in the storage unit. The control unit then reads the information stored in the storage unit as appropriate, and transmits the information to the arithmetic unit. The control unit also transmits the input information to the arithmetic unit as appropriate. The arithmetic unit executes arithmetic processing using the various kinds of information thus received, and stores an arithmetic result in the storage unit. The control unit reads the arithmetic result stored in the storage unit, and outputs it from the output unit. In this way, various kinds of processing and steps are executed. The respective units and means execute the various kinds of processing. The computer may include a processor which achieves various functions and steps. The computer may be a stand-alone computer. The computer may have some of its functions distributed across a server and a terminal. In this case, the server and the terminal are preferably configured to be able to exchange information via a network, such as the Internet or an intranet.

The computer may receive information transmitted wirelessly from various external devices or information output as an optical signal and convert the information to an electrical signal for use. The optical and electrical signals may include various modulation signals in addition to on-off keying. For example, the storage unit may store various kinds of input information based on the presence or absence of a charge or based on multiple physical states including a quantum state.

When extracting a word or a key sentence, the computer may check words or key sentences stored in the storage unit against an input text, and, in a case where a word or a sentence included in the input text matches the word or the key sentence stored in the storage unit, extract the matching word or key sentence. Alternatively, a learning model may be built through machine learning, and, by inputting the input text and the words or the key sentences stored in the storage unit into the learning model, a particular word or key sentence may be output.

For example, the computer may be equipped with a machine learning engine, and through machine learning, the computer may build a trained model using training data and input various kinds of information into the trained model to obtain the various kinds of information. The various kinds of information thus obtained may be stored in the storage unit. The accuracy of the trained model can be improved through feeding back of the obtained various kinds of information. Also, the accuracy of the trained model can be improved by repeatedly inputting the training data and correct answer data, and the training data and incorrect answer data. For example, in this invention the learning model may be built through machine learning using various texts and evaluation values as the training data to obtain a text evaluation. Alternatively, the learning model may be built through machine learning using one or more key sentences and evaluation values (evaluation values indicative of how good texts are) as the training data to obtain the text evaluation. The evaluation value may be obtained by obtaining one or more key sentences for a text that already has the evaluation value and inputting one or more key sentences into the trained model. The evaluation value thus obtained may then be compared with the evaluation value of the text itself, and a result of the comparison may be fed back as the training data to improve the accuracy of the learning model.

The text input step (S101) is a step in which the text to be evaluated is input into the computer. The text input unit 3 in the system 1 may input the text to be evaluated into the system. For example, the text may be input into the computer using an input device (e.g., a keyboard or a mouse). Alternatively, speech from which the text originates may be input into the computer using a microphone or another speech input device. The speech input into the computer may be subjected to speech recognition using a known method to obtain the text to be evaluated. In this case, the computer executes arithmetic processing to digitize the speech, and stores digitized speech in the storage unit as appropriate. The computer may include a speech analyzing unit for analyzing a word or a term included in the speech. The speech analyzing unit can read a speech analysis program and the digitized speech from the storage unit and analyze the speech to obtain the text to be evaluated. The text to be evaluated thus obtained may be stored in the storage unit as appropriate.

When the text to be evaluated is input into the computer, in a case where the text is associated with an article, information relating to the article with which the text is associated may also be input into the computer. This enables the system to execute various kinds of arithmetic processing using various kinds of information relating to the article with which the text is associated. Examples of the arithmetic processing include various kinds of arithmetic in speech analysis, word extraction, sentence extraction, and subsequent text analysis. Examples of the article with which the text is associated include presentation materials, pages of the presentation materials, reports, conference materials, medicines, questions, problems, questionnaires, Q & A collections, telephone records, and chatbot manuals. For example, when a presentation material is activated on a terminal, information relating to the presentation material may be input into the system. In this case, a dictionary and a storage unit relating to the presentation material become available as described below. The text to be evaluated may be any text. Examples of the text to be evaluated include a descriptive text or an answer text. That is, this system can be used to evaluate a text used by a person to give an explanation to another person, or to automatically evaluate an answer text to a question. Further, this system can automatically interpret an input question and effectively create an answer to the question.

For example, a medical representative (MR) inputs information relating to a medicine A into the system or activates a descriptive material relating to the medicine A to display the descriptive material on a display. Then, the system stores information indicating that a subsequent speech or conversation is related to the medicine A in the storage unit.

Then, an MR's speech “NINSHIN MATA WA NINSHIN SHITEIRU KANOSEI NO ARU JOSEI NIWA CHIRYOJO NO YUEKISEI GA KIKENSEI WO UWAMAWARU TO HANDAN SHITA BAAI NI TOYO SHITE KUDASAI (which means “Administer medicine to pregnant women or women who might be pregnant only if it is determined that the therapeutic benefit outweighs the risk” in Hiragana characters)” is input via a microphone.

The system analyzes terms of the speech mentioned above by referring to a term conversion dictionary for the medicine A (a conversion term storage unit for the medicine A). In the term conversion dictionary for the medicine A, words such as “NINPU (which means “pregnant women” in Kanji characters),” “NINSHIN SITEIRU (which means “pregnant” in Japanese characters),” “KANOSEI NO ARU (which means “might be” in Japanese characters),” “JOSEI (which means “women” in Kanji characters),” “CHIRYO (which means “treatment” in Kanji characters),” “CHIRYOJO (which means “therapeutic” in Kanji characters),” “YUEKISEI (which means “benefit” in Kanji characters),” “KIKENSEI (which means “risk” in Kanji characters),” “UWAMAWARU (which means “outweigh” in Japanese characters),” “HANDAN (which means “determined” in Kanji characters),” “BAAI (which means “if” in Kanji characters),” and “TOYO (which means “administer” in Kanji characters)” are stored as high-priority words. For example, since “JOSEI (which means “women” in Kanji characters)” is stored as a word with higher priority than “JOSEI (which means “grant” in Kanji characters)” in this dictionary, “JOSEI (which means “women” in Kanji characters)” is read with priority for “JOSEI” in the input speech mentioned above.

In this way, the text “Administer medicine to pregnant women or women who might be pregnant only if it is determined that the therapeutic benefit outweighs the risk” is input into the system for the medicine A.

The in-text word extracting step (S102) is a step of extracting the in-text word as a word included in the text to be evaluated by the computer. The in-text word extracting unit 5 extracts the in-text word as the word included in the text to be evaluated. The system may include a dictionary relating to the in-text word and extract the in-text word from the text to be evaluated by reading the text to be evaluated from the storage unit and comparing the text with words in the dictionary. Additionally, when the information relating to the article with which the text is associated is input into the computer, a dictionary on the article with which the text is associated that is used for extracting the in-text word (the in-text word storage unit 6) can be used to facilitate extraction of the in-text word. In this case, examples of the in-text word include words stored in the in-text word storage unit that stores the in-text words associated with the text to be evaluated. The system (the in-text word extracting unit 5) can extract the in-text words included in the text to be evaluated by reading the in-text words stored in the in-text word storage unit 6 and comparing the in-text words with the text to be evaluated. The system may store the in-text words thus extracted by the system in the storage unit as appropriate. In this way, the system can obtain the in-text words.

The system includes the in-text word storage unit 6 relating to the medicine A. The in-text word storage unit 6 relating to the medicine A stores words such as “pregnant women,” “pregnant,” “women,” “benefit,” “risk,” “outweigh,” and “administer” as the high priority words.

Therefore, from the text “Administer medicine to pregnant women or women who might be pregnant only if it is determined that the therapeutic benefit outweighs the risk” for the medicine A input into the system, the in-text words “pregnant women,” “pregnant,” “women,” “benefit,” “risk,” “outweigh,” and “administer” are extracted. In a case where the speech is input into the system, the term conversion dictionary and the in-text word storage unit 6 may be the same, although it is preferable that they be different from each other. In other words, although the terms used for term conversion and the words to be extracted as the in-text words may be the same, they may differ because they serve different purposes.

The key sentence extracting step (S103) is a step of extracting the key sentence included in the text to be evaluated by the computer. For example, the key sentence extracting unit 7 extracts the key sentence included in the text to be evaluated. The key sentence includes one or more in-text words and one or more postpositional particles. The key sentence may include one or more in-text words. In a case where one key sentence includes two or more in-text words, the in-text words may be contiguous within the text to be evaluated, or one or more other in-text words or nouns may be present before the in-text words.

In the in-text word extracting step (S102) described above, words included in the text to be evaluated are extracted. However, there is a case in which simply using the words is not enough to determine whether a text (a descriptive text or an answer text) is correct. As such, the system 1 extracts a key sentence in the key sentence extracting step (S103). The key sentence means a phrase used to evaluate whether the text is a correct descriptive text or answer text. The key sentence usually includes two or more words. The key sentence may be stored in the key sentence storage unit 8 that stores a key sentence associated with the text to be evaluated or may be extracted from the text to be evaluated as a key sentence that includes a particular in-text word A and a postpositional particle associated with the in-text word A included in the text to be evaluated. Note that the in-text word extracting step (S102) and the key sentence extracting step (S103) are provided for convenience and may be executed simultaneously. In this case, the in-text word is also extracted when the key sentence extracting step (S103) is executed.

In the former case, the system (the key sentence extracting unit 7) may read one or more key sentences stored in the key sentence storage unit 8 in association with the text to be evaluated, execute arithmetic to compare the one or more key sentences with the text to be evaluated, and extract the key sentence included in the text to be evaluated. The system may store the key sentence included in the text to be evaluated thus extracted in the storage unit as appropriate.

In the latter case, the system (the key sentence extracting unit 7) stores, for example, the in-text word for the key sentence stored in the key sentence storage unit 8 in association with the text to be evaluated. The system may then read the in-text word for the key sentence from the key sentence storage unit 8 and read the in-text word for the key sentence and postpositional particles following the in-text word from the text to be evaluated to extract the key sentence from the text to be evaluated. The system may store the extracted key sentence included in the text to be evaluated in the storage unit as appropriate.

For example, the medicine A is administered to pregnant women or women who might be pregnant only if the benefit outweighs the risk. However, simply extracting the in-text words is not enough to determine whether the text to be evaluated means that the risk outweighs the benefit. Such a text is not correct as a descriptive text for the medicine A. Therefore, the key sentence storage unit 8 stores key sentences such as (“the therapeutic benefit” . . . “outweighs the risk”). The key sentence storage unit 8 may store key sentences such as (“the benefit outweighs”), (“the risk fall below”), and (“the risk is low”). The key sentence storage unit 8 may store the in-text words such as “pregnant women” and “pregnant” for the administration target and the key sentences including any of the above for medical efficacy.

Thus, from the text “Administer medicine to pregnant women or women who might be pregnant only if it is determined that the therapeutic benefit outweighs the risk,” for example, subjects (any or both of “pregnant women” and “pregnant”) and the key sentences (“therapeutic benefit”), (“outweighs the risk”) for the medical efficacy are extracted.

The text evaluating step (S104) is a step of evaluating the text on the basis of the key sentence by the computer. For example, the text evaluating unit 9 evaluates the text to be evaluated on the basis of the key sentence. The system 1 may further include the text evaluation information storage unit 10. The text evaluation information storage unit 10 stores, for example, the key sentence and evaluation information relating to the key sentence. Examples of the evaluation information include information relating to whether the key sentence is correct as the text to be evaluated, information relating to which category the key sentence belongs to, and an evaluation value associated with the key sentence. The system (the text evaluating unit 9) reads the evaluation relating to the key sentence extracted from the text evaluation information storage unit 10 using the key sentence extracted in the key sentence extracting step (S103). In this way, the system 1 can evaluate the text to be evaluated.

The evaluation value associated with the key sentence may be an evaluation value (a score) stored in the storage unit in association with each key sentence. For example, a higher evaluation value may indicate that a more appropriate key sentence has been used. As a result, a text including an appropriate key sentence may have a higher evaluation value and obtain a higher rating. In a case where multiple evaluation values are obtained, the evaluation values may be added together to obtain the evaluation value of the text (an indicator of how good the text is).

For example, the text evaluation information storage unit 10 stores “correct” as the evaluation in association with the key sentences including (any or both of “pregnant women” and “pregnant”), (“therapeutic benefit”), and (“outweighs the risk”) in association with the medicine A. The text evaluating unit 9 then reads the evaluation “correct” from the text evaluation information storage unit 10 using the key sentences mentioned above. The text evaluating unit 9 may store the evaluation “correct” thus read as the evaluation of the text to be evaluated in the storage unit. After that, the system 1 may output the evaluation “correct”. It is assumed that a category “dosage prescription” is stored in the text evaluation information storage unit 10 in association with the key sentences (any or both of “pregnant women” and “pregnant”), (“therapeutic benefit”), and (“outweighs the risk”). Then, the system 1 reads the category “dosage prescription” as one of the evaluations in association with the medicine A using the extracted key sentences. In this case, the system 1 may obtain the evaluation “correct” for the category “dosage prescription” in association with the medicine A.

The in-text word storage unit 6 may store word classifications in association with the in-text words. Examples of the classifications include affirmative, negative, and ambiguous. Table 1 shows exemplary classifications and in-text words for each classification. In a case where the key sentence includes the in-text word, the key sentence storage unit 8 may store the classification of the in-text word. The text evaluation information storage unit 10 may store the classification of the in-text word included in the key sentence. The system (the text evaluating unit 9) reads the evaluation concerning the key sentence extracted from the text evaluation information storage unit 10 using the key sentence extracted in the key sentence extracting step (S103). For example, the system 1 reads information relating to the classification of the in-text word included in the key sentence (e.g., affirmative, negative, and ambiguous) from the text evaluation information storage unit 10 (the key sentence storage unit 8 or the in-text word storage unit 6). In a case where the classification of the in-text word included in the read key sentence is negative (or ambiguous), the text to be evaluated may be evaluated as incorrect (inappropriate). This allows preventing ambiguous text expressions from being used and improving an answering ability.

This specification also includes an invention of extracting the in-text word, in lieu of the key sentence, from the text to be evaluated and evaluating the text to be evaluated based on the classification of the in-text word thus extracted. In this invention, the key sentence extracting step (S103) and the key sentence extracting unit 7 are not necessary.

TABLE 1

| Affirmative | Negative | Ambiguous |
|---|---|---|
| is | is not | probably |
| was | was not | more or less |
| there was | there was not | considerably |
| can | can not | quite |
| say(s) | do(es) not say | think(s) |

The subsequent text creating step (S105) is a step of obtaining a subsequent text as a text following the text to be evaluated, based on the evaluation. The subsequent text creating unit 11 may obtain the subsequent text as the text following the text to be evaluated. The computer includes, for example, the subsequent text storage unit 13 that stores a subsequent text corresponding to an evaluation. In the subsequent text creating step (S105), the computer reads the subsequent text corresponding to the evaluation using the evaluation of the text to be evaluated. Information relating to an article with which the text is associated is input into the computer, and an appropriate subsequent text may be read from the subsequent text storage unit 13 corresponding to the information relating to the article with which the text is associated. For example, when the information relating to the article with which the text is associated is “a question” and the evaluation is “correct” (a correct answer), the subsequent text storage unit 13 stores an evaluation “well done” and a description relating to the question. The system (the subsequent text creating unit 11) reads the evaluation from the storage unit, reads the subsequent text “well done” corresponding to the evaluation as well as a description relating to the question from the subsequent text storage unit 13, and then stores them in the storage unit as appropriate. The subsequent text thus read may be output as appropriate. In a case where the information relating to the article with which the text is associated is a chatbot associated with a product and the evaluation is “problem identification” (category), the system may obtain an appropriate answer by reading an answer corresponding to the text to be evaluated from the subsequent text storage unit 13 based on the evaluation. In this way, the system can obtain the subsequent text. For example, when the evaluation of the text is “interrogative sentence” or “question,” an answer to the text can be obtained.

It is assumed that the system 1 receives an input “Administer medicine to pregnant women or women who might be pregnant only if it is determined that the therapeutic benefit outweighs the risk” for medicine A and extracts the in-text words and the key sentences from the text to obtain the evaluation “correct” for the category “dosage prescription” in association with the medicine A. For example, the subsequent text storage unit 13 stores a subsequent text “The dosage frequency of the medicine A is one tablet per day.” relating to the above evaluation “correct” for the category “dosage prescription” in association with the medicine A. The system (the subsequent text creating unit 11) may read the above evaluation from the storage unit and the above subsequent text from the subsequent text storage unit 13 and store them in the storage unit. Also, the system may output the above subsequent text. Thereby, the subsequent text “The dosage frequency of the medicine A is one tablet per day.” is output.

### Computer-Based Learning Support

Examples of the use of the above method and system include a computer-based learning support method. This specification also discloses a learning support system using the above system. This aspect of the invention may be provided in a downloadable format as a learning support application. In this case, various dictionaries for each question are stored on a server or installed in a mobile terminal. In this system, for example, a question A is stored from the storage unit and displayed on a display of the terminal. A user answers the question by speech. The user's speech is input into the terminal via an input unit of the terminal. The speech (the user's answer) thus input is stored in the terminal as a text to be evaluated. The system including any or both of the terminal and the server includes one or more of a term conversion dictionary, the in-text word storage unit 6, the key sentence storage unit 8, the text evaluation information storage unit 10, and the subsequent text storage unit 13 relating to the question A. Therefore, the system can evaluate the user's answer. Also, the system can read a subsequent text corresponding to the user's answer and display the subsequent text on the display of the terminal. As will be described later, memorizing texts rather than simply memorizing words helps to reinforce memories and improve communication skills. Accordingly, the learning support system and the learning support method using this invention can provide the user with a high learning effect.

### Chatbot and Role-Playing System

Examples of the use of the above system include a chatbot and a role-playing system.

The chatbot and the role-playing system include one or more of a term conversion dictionary, the in-text word storage unit 6, the key sentence storage unit 8, the text evaluation information storage unit 10, and the subsequent text storage unit 13 relating to a particular product or service. Thereby, in response to a speech input by telephone and an input of a question, etc., automatically input by the Internet into the system, the system can obtain a key sentence, an evaluation relating to the product or service, and then a subsequent text as appropriate. Accordingly, the system can automatically output an appropriate answer to the question. In this case, for example, for an input “A wheel of the product AA has stopped moving”, the system may obtain a subsequent text “Is the power on?” using the storage unit relating to the product AA and output the subsequent text to a questioner. When the user inputs “Yes” to this response, the system may obtain a subsequent text “Please clean the area around the wheel with a brush. If the wheel still does not move, please inform the service center, and we will come to collect it.” and output it to the questioner.

### Conversation or Presentation Assist System

Examples of the use of the above system include a conversation or a presentation assist system. This system includes, for example, one or more of a descriptive material, a presentation material, a term conversion dictionary for each page of the presentation material, the in-text word storage unit 6, the key sentence storage unit 8, the text evaluation information storage unit 10, and the subsequent text storage unit 13. Thereby, when a conversation or presentation is conducted based on the material or the presentation material, the system can obtain a key sentence. Using the key sentence, an appropriate evaluation can be obtained from the text evaluation information storage unit 10, and an appropriate subsequent text can be obtained from the subsequent text storage unit 13. In this case, the evaluation may be “very good,” “excellent,” or “good. The subsequent text may be an explanation that leads to an improvement in the conversation or presentation, such as “It is better to use BBB rather than AAA for an explanation to obtain a higher evaluation.”

This specification also discloses a program including instructions to cause the computer to execute the methods described above and for causing the computer to function as the system described above, and non-transitory computer readable information recording media (e.g., CD-ROMs, DVDs, SD cards, and USB memories) that store the program.

### Example 1

### Consideration of Learning Models Using Speech Learning

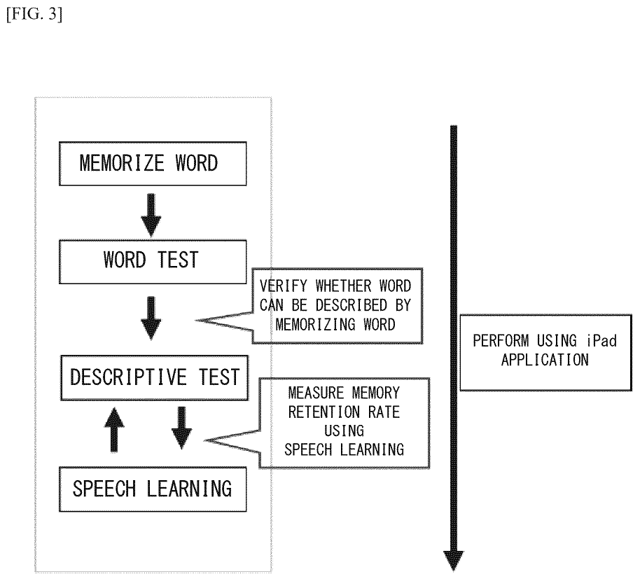

Through three steps of “word and descriptive text becoming fixed in memory,” “replacing the fixed memory with one's own words,” and “being able to provide a clear explanation,” it is believed that one becomes capable of providing clear explanations. In this example, verification results of “word and descriptive text becoming fixed in memory” and “replacing the fixed memory with one's own words” are considered. This study verifies the three verification items presented below. In the following experiment, an application implementing the computer-based learning support system described in this specification was used as a role-playing application. An overview is illustrated in FIG. 3.
(i) Verification of memory retention in word memorization learning
(ii) Measurement of retention rate of word descriptive texts using speech learning (Pharmaceutical-related questions were given, and 10 men and women aged 20s to 50s were selected as subjects. The subjects were divided into two groups and given the same content.)
(iii) Measurement of retention rate and learning time using role-playing application on iPad (registered trademark)
(Network-related questions were given, and 6 men and women aged 30s to 50s were selected as subjects and tested.)

### Verification of Memory Retention in Word Memorization Learning

First, to verify how many words can be memorized through silent reading, 21 specialized terms related to the pharmaceutical industry as words not used in daily life were picked, and questions were created. The overview of the relevant words and descriptive texts is shown in Table 2.

TABLE 2

| Word | Exemplary description |
|---|---|
| Antiemetic | Medication prescribed to suppress vomiting when it |
| | does not stop and dehydration occurs. |
| Bioavailability | Also known as BA, it is an indicator of how much of |
| | a medicine administered to the human body circulates |
| | throughout the body. |
| Dosage form | A general term for different types of medications, such |
| | as tablets, capsules, and granules. |
| Vial | A container for injectable medicines, consisting of a |
| | glass or plastic bottle with a rubber stopper that can |
| | prevent the entry of microorganisms and maintain a |
| | sterile condition. |

On the first day of the verification experiment, A4 sheets with words and descriptive texts were handed to the subjects. The subjects were asked to memorize the words using methods (e.g., visual observation, writing on paper) other than verbal repetition for 10 minutes on the spot. After 10 minutes, the descriptive texts of the words were converted into a question form and read aloud to the subjects as questions. For incorrect answers, correct answers were provided orally to the subjects on the spot. On the second and third days, tests alone were conducted to observe how memory retention changed and to tally the number of correct answers by the subjects.

Measurement of retention rate for word descriptive texts using speech learning After a three-day word test was completed, a test of whether the subjects could speak the word descriptive texts was conducted to measure how well the subjects could recall the descriptive texts for the words. The test involved orally asking the subjects to explain 21 words by saying, “Please explain about X,” and recording their responses (using the iPad (registered trademark) voice recognition function for efficiency). Then, as shown in Table 3, similar tests were conducted repetitively and periodically over a total of 19 days (please note that due to work circumstances, the test dates were not evenly distributed). The retention rate of the word descriptive texts was measured by recording the results.

TABLE 3

| Day | 1 | 2 | 5 | 6 | 9 | 19 |
|---|---|---|---|---|---|---|
| Memory | ∘ | ∘ | ∘ | ∘ | ∘ | ∘ |
| Test | | | | | | |
| Speech | | 10 | | 10 | 10 | |
| Learning | | | | | | |
| (min) | | | | | | |
| Validation | | ∘ | | ∘ | ∘ | |
| Test | | | | | | |

Additionally, to measure a memory retention effect of speech learning, the subjects were asked to conduct speech learning three times at intervals of approximately 3 to 4 days from the first measurement day. The content of the speech learning involved handing out A4 sheets with words and descriptive texts shown in Table 1 similarly to the above verification, and asking the subjects to memorize the word descriptive texts by reading them aloud for 10 minutes on the spot. The “memory test” in Table 2 refers to the test to see how well the subjects can speak the word descriptive texts, and the “verification test” refers to the test conducted immediately after the speech learning to check how well the subject can speak the word descriptive texts.

Measurement of Retention Rate and Learning Time Using Role-Playing Application on iPad (Registered Trademark)

Using the iPhone (registered trademark) and iPad (registered trademark) application “iRolePlay (registered trademark)” developed by Interactive Solutions (registered trademark) Corporation, the retention rate and learning time of the words and the descriptive texts were measured.

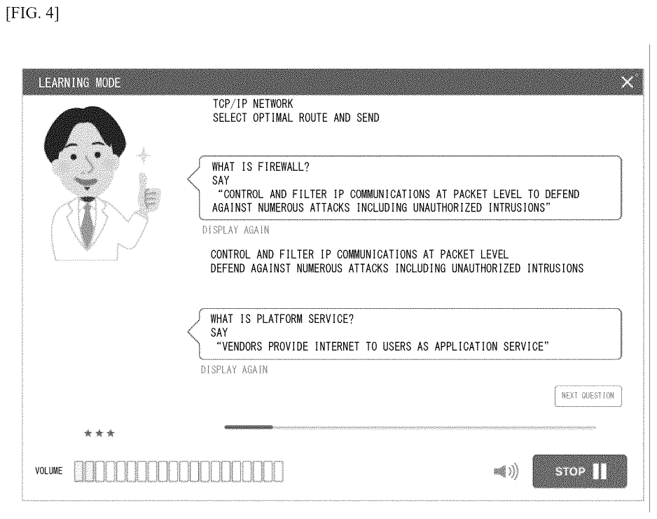

“iRolePlay (registered trademark)” is a new-generation reskilling tool that helps a user “acquire the ability to explain and make proposals” through objective analysis, evaluation, and advice functions provided by AI utilizing voice recognition of a user's speech and the Neural Engine incorporated in iPhone (registered trademark) and iPad (registered trademark). The application consists of two modes (a learning mode and a challenge mode), the former of which displays answers to questions read aloud, allowing the user to practice speaking (FIG. 4). The latter enables the user to acquire practical explanatory skills through speaking practice by responding to questions read aloud.

Target questions consisted of 21 network-related words that were unfamiliar to the subjects. Two courses were prepared, one for learning words and the other for learning word descriptive texts. The subjects were given iPads (registered trademark) and encouraged to engage in self study during their spare time amidst their work schedule over three days. As illustrated in FIG. 4, the subjects used the learning mode in which the questions and answers were displayed on the iPad (registered trademark) and learned in a role-playing format by speaking. In this application, the user can proceed to the next question by speaking a correct word or word descriptive text. For a test, the challenge mode was used, in which questions inquiring about the words or questions made by converting the word descriptive texts into question forms were given verbally. Whether the questions were answered correctly was determined by voice recognition.

### Experimental Results and Consideration

### Verification of Memory Retention Rate in Word Memorization Learning

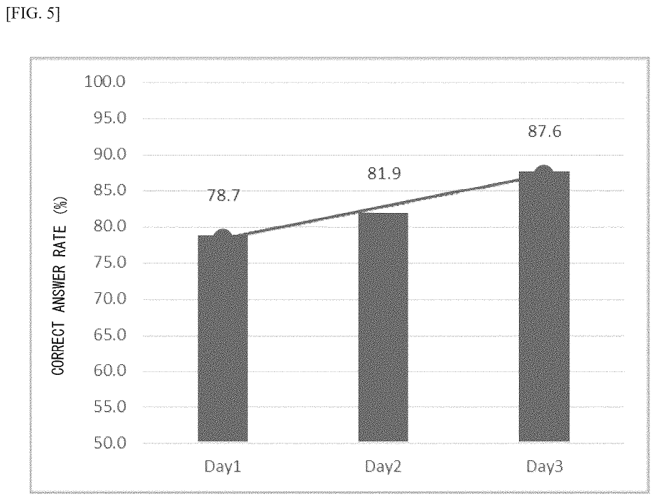

Although speaking words aloud is effective for memorizing the words as mentioned earlier, memorizing the words by visual learning or writing on paper for 10 minutes yielded a correct answer rate of 78.6%. Furthermore, the correct answer rate increased to 81.9% on the second day, when there was no time provided for memorization, and 87.6% on the third day, indicating an increasing trend (FIG. 5).

### Consideration

It is generally believed that memories are forgotten over time, as is known from the “Ebbinghaus forgetting curve”. However, in this verification, it is considered that teaching the correct answers to the subjects immediately after incorrect answers contributed to easier retention of the correct answers and consequently improved test scores. In fact, during interviews with the subjects, three of them commented that they remembered the correct answers they had been given to questions in response to their wrong answers on the previous test. It was demonstrated that immediate feedback of the correct answers to incorrect answers was effective for memory retention in memorizing words.

### Measurement of Retention Rate of Word Descriptive Texts Using Speech Learning

While the correct answer rate of a word test was 87.6%, the correct answer rate of a word descriptive test was 43.3%, which was less than half. This result proves that even if the subjects can answer a word in a question-and-answer format, it was not necessarily meant that they can explain the words.

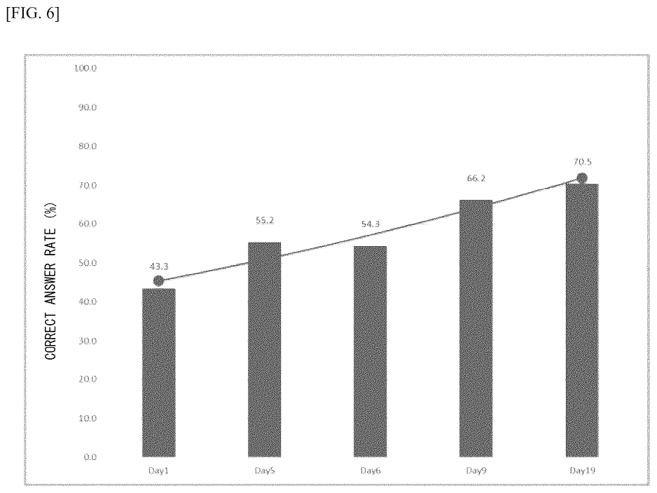

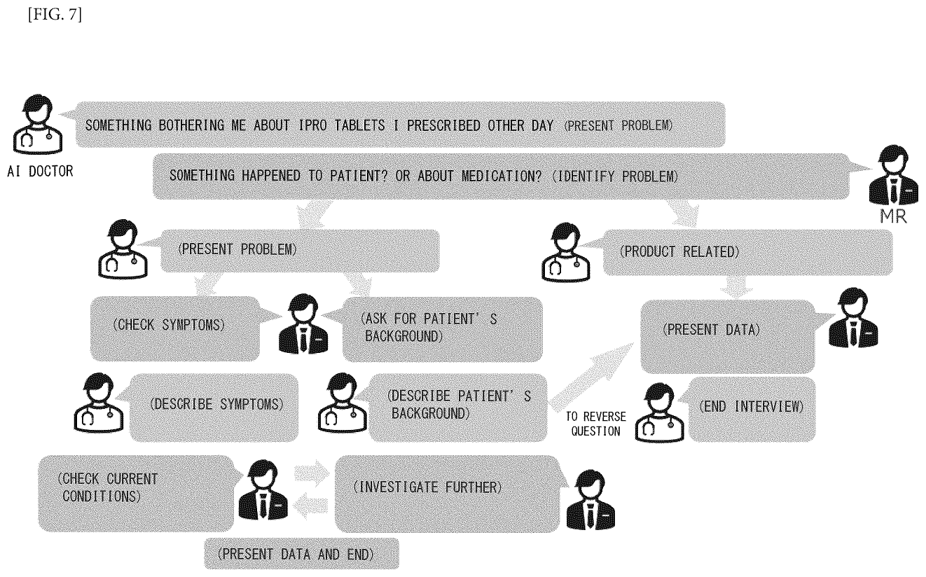

Here, the results on memory for the word descriptive texts will be presented. In the word descriptive test, a comparison between the results of visual learning and speech learning indicates that the latter showed a 64% increase in the correct answer rate compared to the former. In addition, a trend of the correct answer rate for the word descriptive test, that is, the trend of the memory retention rate, is as shown in FIG. 6. When speech learning was performed regularly, the correct answer rate indicated an increasing trend throughout the entire schedule. An answer rate remains above 70% even 19 days after a first word descriptive test.

### DISCUSSION

By repeating the speech learning, the subjects were able to speak answers similar to the exemplary answers (the exemplary descriptions shown in FIG. 3). Analysis of the subjects' answers recorded using speech recognition indicates an increase in the proportion of technical terms used in their answers with repeated speech learning. Feedback from the subjects revealed that even for the technical terms that they do not normally use, speaking them aloud or hearing them were advantageous when answering verbally. As the number of tests increased, the subjects became more fluent in answering using the technical terms, and the correct answer rate gradually increased simultaneously. To develop explanatory skills, it is necessary to use appropriate expressions with occasional use of the technical terms when speaking to others. In this regard, this verification suggested that by speaking aloud, the technical terms became more ingrained in memory, and the subjects became familiar with speaking the words, allowing the subjects to explain smoothly in their own words.

This verification also revealed that once a descriptive text is memorized, it tends to become a long-term memory. When examining the answers to the 21 questions, it was found that the correct answer rate did not decrease over time for the questions that were initially answered correctly. Feedback from two subjects indicated that by remembering the words as the keywords within the descriptive texts, they were able to accurately explain during the word descriptive test.

Measurement of Retention Rate and Learning Time Using Role-Playing Application on iPad (Registered Trademark)

Although verification using the role-playing application on iPad (registered trademark) is still in progress, the progress of the correct answer rate for word descriptive texts indicates a similar trend. The most significant advantage was that the only time it took for educators to conduct the measurement was for distributing the application. In the above verification, it took 2,480 minutes to improve the scores of 10 subjects, including all the following steps: setting the test questions, providing feedback on correct answers to incorrect answers, and grading the test results.

Another advantage is that the subjects can learn any time using their free time. Since logs can be obtained from the application, the learning time can be accurately measured, which is expected to lead to superior learning guidance for educators. A future task is to verify how effectively subjects can utilize their spare time and reduce the time to improve their correct answer rate for the word descriptive texts.

In this study, an explanatory ability is defined as “the ability to explain to others using appropriate expressions”, and we considered that there are three steps to establish the explanatory ability. In verifying the memory retention of word memorization learning, it was demonstrated that immediate feedback on incorrect answers is effective for memory retention. On the other hand, it was proven that even if one can answer word questions in a question-and-answer format, it is not necessarily meant that they can explain the words.

In measuring the retention rate of word descriptive texts using speech learning, it was revealed that repeating speech learning improves the retention rate of the word descriptive texts. Furthermore, from the content of the word descriptive test by the subjects, it was demonstrated that following the three steps increases the correct answer rate.

### Example 2

### Role-Playing

FIG. 7 is a conceptual diagram illustrating a concept of role-playing. The “brackets” in the figure are the categories for evaluation.

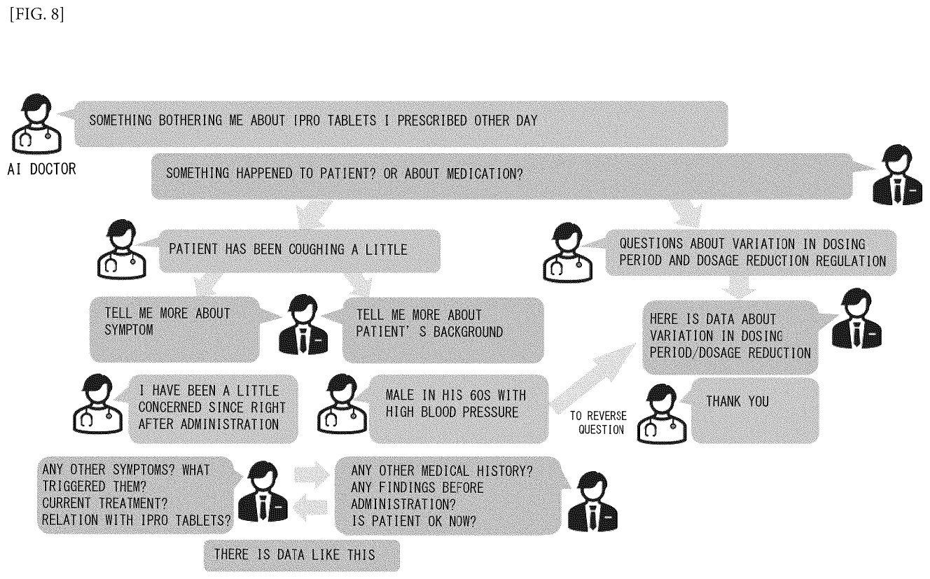

FIG. 8 is a conceptual diagram illustrating an example of role-playing in which the response of an AI doctor branches based on answers provided by an MR.

An actually developed application was installed on the computer, and the computer was caused to execute commands according to the application. The following Qs are input texts to be evaluated, and As are subsequent texts to them.
Q. What is the patient's medical history?
A. Myocardial infarction 3 years ago.
Q. Any other symptoms?
A. It seems the patient has headaches and dizziness.
Q. Findings before administration?
A. I thought it was stress-related.
Q. Current treatment?
A. I have been providing a diet therapy and an antihypertensive medication.
Q. Relation with Ipro tablets?
A. Ipro tablets are easy to prescribe because they cause few respiratory side effects.

In this example, in response to the doctor's input of a question, the term conversion dictionary, the in-text word storage unit 6, the key sentence storage unit 8, the text evaluation information storage unit 10, and the subsequent text storage 13 relating to a medical field and a target patient are first referenced, and the appropriate subsequent texts are displayed on the display. In the conversation, the “Ipro tablets” appeared as the in-text word. Therefore, the system refers to the key sentence storage unit 8, the text evaluation information storage unit 10, and the subsequent text storage unit 13 related to Ipro tablets, whereby the appropriate subsequent texts are obtained. Because this system executes a key sentence analysis, the chatbot and role-playing become interactive, enabling natural dialogue even using computers. Also, unlike conventional conversational systems using deep learning, this system allows building conversations in a specific domain very easily without taking much time. Role-playing using this system was effective in cultivating advanced conversation skills.

### INDUSTRIAL APPLICABILITY

This invention can be used in the information and education industries.

### REFERENCE SIGNS LIST

1 System
3 Text input unit
5 In-text word extracting unit
6 In-text word storage unit
7 Key sentence extracting unit
8 Key sentence storage unit
9 Text evaluating unit
10 Text evaluation information storage unit
11 Subsequent text creating unit
13 Subsequent text storage unit

1. A method for evaluating a text by a computer, comprising:
a text input step in which a text to be evaluated is input into the computer;
an in-text word extracting step of extracting an in-text word as a word included in the text to be evaluated by the computer;
a key sentence extracting step of extracting a key sentence included in the text to be evaluated by the computer, the key sentence including one or more in-text words and one or more postpositional particles; and
a text evaluating step of evaluating the text on a basis of the key sentence by the computer, wherein
the text evaluating step includes a step of reading evaluation information relating to the key sentence from a storage unit, and
the evaluation information is information relating to whether the key sentence is correct as the text to be evaluated, or information relating to which category the key sentence belongs to.

2. The method according to claim 1, wherein
the text input step includes:
a step in which a speech is input into the computer; and
a step of analyzing the speech to obtain the text to be evaluated by the computer.

3. The method according to claim 1, wherein
the text to be evaluated is a descriptive text or an answer text.

4. The method according to claim 1, wherein
the evaluation information is information relating to which category the key sentence belongs to.

5. The method according to claim 1, wherein
the key sentence is allowed to be a group of words that are either contiguous or dispersed within the text to be evaluated.

6. A computer-based learning support method comprising
a step of evaluating the text to be evaluated based on the method according to claim 1.

7. A system (1) for evaluating a text by a computer, comprising:
a text input unit (3) for inputting a text to be evaluated;
an in-text word extracting unit (5) for extracting an in-text word as a word included in the text to be evaluated;
a key sentence extracting unit (7) for extracting a key sentence included in the text to be evaluated, the key sentence including one or more in-text words and one or more postpositional particles; and
a text evaluating unit (9) for reading evaluation information relating to the key sentence from a storage unit to evaluate the text to be evaluated either on a basis of or using the key sentence, wherein
the evaluation information is information relating to whether the key sentence is correct as the text to be evaluated, or information relating to which category the key sentence belongs to.

8. A program for causing a computer to execute a method for evaluating a text, the method comprising:
a text input step in which a text to be evaluated is input into the computer;
an in-text word extracting step of extracting an in-text word as a word included in the text to be evaluated by the computer;
a key sentence extracting step of extracting a key sentence included in the text to be evaluated by the computer, the key sentence including one or more in-text words and one or more postpositional particles; and
a text evaluating step of evaluating the text to be evaluated on a basis of the key sentence by the computer, wherein
the text evaluating step includes a step of reading evaluation information relating to the key sentence from a storage unit, and
the evaluation information is information relating to whether the key sentence is correct as the text to be evaluated, or information relating to which category the key sentence belongs to.

9. A non-transitory computer readable information recording medium storing the program according to claim 8.
